(19) United States
(12) Patent Application Publication
(10) Pub. No.: US 2016/0354886 A1
(43) Pub. Date: Dec. 8, 2016

(54) METAL CUTTING MACHINE TOOL

(71) Applicant: H.C. Burkhart Grob, Bad Worishofen (DE)

(72) Inventor: H.C. Burkhart Grob, Bad Worishofen (DE)

(73) Assignee: GROB-WERKE GmbH & CO. KG, Mindleheim (DE)

(21) Appl. No.: 15/172,119

(22) Filed: Jun. 2, 2016

(30) Foreign Application Priority Data
Jun. 2, 2015 (DE) 10 2015 108 701.4

(51) Int. Cl. B23Q 7/06; B23Q 7/05

(52) U.S. Cl. CPC B23Q 7/06; B23Q 7/05

(57) ABSTRACT

The invention refers to a metal cutting machine tool, with a motor spindle, which is also used for moving a work piece between the preparation area and the work piece table. The invention also refers to a corresponding method and to a corresponding system.

### FIELD OF THE INVENTION

The invention refers to a metal cutting machine tool. It comprises at least one motor spindle rotatably driving a respective tool. It is also provided with a work piece table, at or on which the at least one work piece is clamped, directly or indirectly by means of a pallet carrying the work piece during the machining. For transporting the work piece or the pallet carrying the work piece from a preparation area to the work piece table and back, a sliding or rolling track is provided on the work piece surface, on which the work piece or pallet is resting, or the pallet is provided on its underside with sliding rails or rollers. The motor spindle may be movably positioned by a first motor spindle linear drive at least along a first linear axis. The invention also refers to a method for swapping in a work piece on a work piece table, which can be performed, in particular, by means of above said machine tool.

### BACKGROUND OF THE INVENTION

In known metal cutting machine tools, a work piece to be machined is typically positioned on the preparation area on the machine tool or pallet. Thereafter, the work piece is either manually displaced, in order to position it in the active area of the tool held in the motor spindle, or a special electric or hydraulic drive is used to this end.

However, it has been found, that the manual displacement causes higher costs and susceptibility to errors and that the use of a special drive for displacing the work piece of pallet causes high costs.

### SUMMARY OF THE INVENTION

The object of the invention is therefore to provide a metal cutting machine tool, which is improved, with respect to known machine tools, in particular regarding the handling and/or costs. A further object of the invention is to provide a corresponding method for swapping in a work piece, which may be used with above said machine tool. A further object of the invention consists in providing a system with such a machine tool and a pallet.

This is achieved, according to the invention, by a machine tool according to the independent device claims, by a method according to the independent method claim as well as by a system according to the system claim. Advantageous embodiments may be obtained from the respective dependent claims, for example.

The invention refers to a metal cutting machine tool. It comprises at least one motor spindle rotatably driving a tool. It also comprises a work piece table, at or on which the at least one work piece is clamped, directly or indirectly by means of a pallet carrying the work piece during the machining. For transporting the work piece or the pallet carrying the work piece from a preparation area to the work piece table and back, a sliding or rolling track is provided on the work piece surface, on which the work piece or pallet is resting, or the pallet is provided on its underside with sliding rails or rollers. The motor spindle may be movably positioned by a first motor spindle linear drive at least along a first linear axis.

According to the invention it is envisaged that the motor spindle linear drive is also used for moving the work piece from a preparation area to the work piece table and back.

In this way, a manual displacement as well as the provision of a separate drive for displacing the work piece or pallet may be omitted. With respect to the manual displacement, therefore, operating steps are eliminated and defect sources are avoided. Costs for apparatus are also avoided with respect to a separate drive.

A machine tool is typically used for metal cutting machining of work pieces such as motor blocks. By means of the tool, holes may for instance be drilled, surfaces may be structured or edges may be straightened. Therefore, the tool may for instance be a drill bit or a grinding tool.

If a pallet is used, it is typically provided with apparatus for holding and/or fixing the work piece. The work piece may therefore be fixedly connected to the pallet.

The preparation area is usually the portion of the machine tool, which is provided for loading the work piece and removing the work piece after the machining.

A sliding track typically comprises a surface, on which the work piece or the pallet, optionally by means of sliding rails or similar elements, may glide.

A rolling track typically comprises a surface, on which a plurality or a multitude of rollers are disposed, wherein, normally, each roll is individually rotatable. With respect to a sliding track, in this case, friction and wear can be particularly reduced.

The pallet may be configured according the configuration of a sliding or rolling track on the work piece table surface, in order to facilitate a smooth movement of the pallet with the work piece between the preparation area and the work piece table. To this end, sliding rails or rollers may be provided on the underside of the pallet, for example.

The motor spindle linear drive is typically provided for moving the motor spindle along one or more, in particular three, spatial directions. Usually, the motor spindle linear drive may move the motor spindle at least along a Z-direction, which is a direction parallel to the work piece table surface and/or the horizontal direction. This capacity may be used, in the context of the invention, in particular for moving the work piece from the preparation area to the work piece table.

The motor spindle linear drive may be provided for moving the motor spindle in one spatial direction only. In this case, for each spatial direction a dedicated motor spindle linear drive may be provided. The motor spindle linear drive however may also be provided for moving in two or three spatial directions.

It is to be noted that the motor spindle linear drive is typically also provided in machine tools according to the state of the art, and is now provided with an additional function, without losing any efficiency. The work piece swap typically takes place in times, where no machining of the work piece is performed, so that the motor spindle is inactive. Exactly during these swap pauses should the motor spindle be additionally used, according to the inventive proposal.

The drives, which are provided anyway, are suitable and configured for transporting the work piece, i.e. this additional machining comfort does not cause additional costs.

It is understood that the spindle or a coupling piece held in the spindle, may engage the pallet as well as the work piece directly, for instance a motor block. The latter is considered in particular when no pallet is used. However, even when using a pallet, the spindle or the coupling piece may engage the pallet or the work piece, wherein in the latter case, the pallet may be moved along with it.

According to an embodiment, the motor spindle is coupled with the pallet or work piece, for transmitting a moving force for transporting the work piece from the preparation area to the work piece table or back, and the moving force is derived from the motion, caused by the motor spindle linear drive, of the same motor spindle. This allows for a direct connection of the motor spindle linear drive for moving the work piece.

Preferably, in the tool holder of the motor spindle a coupling piece may be inserted. Further preferably the coupling piece cooperates, for transmitting the moving force to the work piece or pallet, with a coupling counterpiece which is provided on the work piece or on the pallet.

By using such a coupling piece, the force transmission may be improved. The coupling piece and counterpiece may be provided in such a way that the force transmission, in particular in relevant directions, is optimized. The coupling counterpiece may for example be completely or partially complementary to the coupling piece. In this way, and also in different ways, a formfitting engagement of the coupling piece into the counterpiece may be achieved, for example.

It is suitably envisaged that the coupling counterpiece is provided with at least one undercut, which cooperates in a formfitting way with at least one element of the coupling piece, in order to transmit a moving force both in a pulling and pushing direction. This allows for a particular efficient force transmission.

According to an embodiment, it is envisaged that the coupling piece is provided with at least one radially outwards or inwards protruding portion, with respect to the motor spindle axis and that the motor spindle rotates the coupling piece protruding into or engaging over the coupling counterpiece in such a way that the protruding portion cooperates with the edge delimiting the undercut. The rotatability of the motor spindle, which is usually already provided, may be therefore used for mutually engaging the coupling piece and coupling counterpiece and provide a formfitting connection. A displacement of the work piece or pallet during the process, in which the coupling piece and counterpiece are connected to each other, may therefore be advantageously omitted.

The coupling piece may in particular be provided on a portion, in particular an end portion opposed with respect to the stem, with a polygon used for transmitting a torque. The end portion is advantageously provided with an elastic support. In this way, a torque may be transmitted, which may be used for driving the elements of the work piece or the pallet. In particular clamping devices may be driven, which hold and/or fix the work piece, for example.

According to an embodiment it is envisaged that the motor spindle may be movably positioned along a second linear axis (Y), forming an angle, preferably perpendicularly, with respect to the first linear axis (Z), by a second motor spindle linear drive. The motor spindle may also be rotatably positioned about a first rotation axis, by a rotary drive and in particular the rotation axis may be perpendicular to the first (Z) and/or second linear axis (Y). This corresponds to a practical embodiment of a motor spindle linear drive.

The work piece table may advantageously be movably positioned forming an angle, preferably perpendicularly, with respect to the rotation axis, by a work piece table drive. This allows for the positioning of the work piece during the machining, for example.

The moving force preferably results from a superposition of the linear movement of the motor spindle along the first (Z) and/or second linear axis (Y) and/or the rotational movement of the motor spindle around the rotation axis. This allows for an advantageous use of the movement possibilities typically provided by a motor spindle linear drive.

During the transmission of the moving force, the motor spindle axis may form an acute angle with the first linear axis (Z). The motor spindle axis may also be parallel to the direction of the moving force. By corresponding orientations, desired force distributions may be achieved and the movement of the motor spindle, which is required for the transition between the machining and moving function, may be reduced.

The invention also refers to a metal cutting machine tool, with at least one motor spindle rotatably driving a respective tool and a work piece table. The work piece is clamped on the work piece table during the machining. For transporting the work piece from a preparation area to the work piece table and back, on the work piece table surface a roller track is provided, on which the work piece or the pallet rest for transport. The motor spindle may be movably positioned at least along a first linear axis (Z) by means of a first motor spindle linear drive.

According to the invention it is envisaged that the motor spindle linear drive is used also for moving the work piece from the preparation area to the work piece table.

In this way, similar advantages may be obtained, as those previously described with reference to the previously described metal cutting machine tool. It is also understood that all embodiments and variants previously or elsewhere described may correspondingly be applied.

The invention also refers to a method for swapping in a work piece from a preparation area to a work piece table within a metal cutting machine tool. The latter may in particular be a machine tool according to the invention, wherein reference can be made to all embodiments and variants described in the present application.

In the tool holder of the motor spindle of the machine tool, at least a coupling piece is swapped in. Therefore the motor spindle is positioned with the coupling piece by the motor spindle linear drive on the work piece or on the pallet carrying the work piece in such a way that a moving force for feeding the work piece from the preparation area to the work piece table may be transmitted. After the work piece has been positioned on the work piece table, the coupling piece is released from the tool holder, and a metal cutting tool is swapped in.

By the inventive method, the advantages previously cited with reference to an inventive metal cutting machine tool may be achieved. In particular, a manual displacement of the work piece and the provision of a separate drive for displacing the work piece may be omitted.

After the motor spindle has positioned the work piece on the work piece table, the motor spindle may be separated from the pallet or the work piece. Then, the motor spindle may be positioned on the work piece table such that the coupling piece held by the motor spindle is connected to a power supply of the work piece table, so that power for performing the operations of the work piece table, such as, for example, a lowering of the work piece or of the pallet onto the work piece table or a clamping of the work piece on the work piece table, is supplied to the work piece table.

This allows for the driving of elements on the pallet, the work piece table or the work piece, such as clamping devices, which may be used for holding and fixing the work piece or the pallet. No additional drive is required in this case too, since the necessary power or movement may be provided by the motor spindle, which is already provided for performing the machining.

The invention also refers to a system. This system is provided with a metal cutting machine tool according to the invention, wherein reference may be made to all previous embodiments and variants. The system also comprises a pallet which directly or indirectly carries a work piece. The motor spindle linear drive also provides for movement of work piece from preparation area to work piece table and back.

In the inventive system the previously described advantages of an inventive machine tool are also achieved.

It is understood, that previously described configurations of parts or components, such as a pallet, a coupling piece or a coupling counterpiece are relevant in particular in the context of an inventive system, since, in particular, such components may be part of a system.

In this context it is in particular pointed out that all features and properties as well as the methods described with reference to a device, i.e. in particular the machine tool and the system, may analogously be transferred to the formulation of the inventive method, and have to be considered usable and disclosed. The same holds in the opposite sense, i.e., constructive, i.e. device related features only cited with reference to the method, may also be considered and claimed in the context of the device claims, and are also considered part of the disclosure.

The invention also refers to the use of a motor spindle for moving a work piece between the preparation area and the machining table.

### BRIEF DESCRIPTION OF THE DRAWINGS

The invention is schematically shown in the drawing, in particular with reference to an exemplary embodiment. In particular:

FIG. 1 is a first view of a machine tool according to the invention;

FIG. 2 is a second view of a machine tool according to the invention;

FIG. 3 is a third view of a machine tool according to the invention;

FIG. 4a is a view of a detail of the inventive machine tool; and

FIG. 4b is a view of a detail of the inventive machine tool.

### DETAILED DESCRIPTION

In figures, same or corresponding elements are provided with the same references, respectively, and are not newly described, if not necessary. The disclosure contained in the whole description may be transferred analogously to equal parts with same references or same component definitions. The positional data chosen in the description, such as up, down, side, etc., also refer to the instant represented figure and have to be transferred, analogously, to the new position, in case of a change of position. Moreover, also individual features or feature combinations from the different exemplary embodiments shown and described may represent independent inventive solutions or solutions according to the invention.

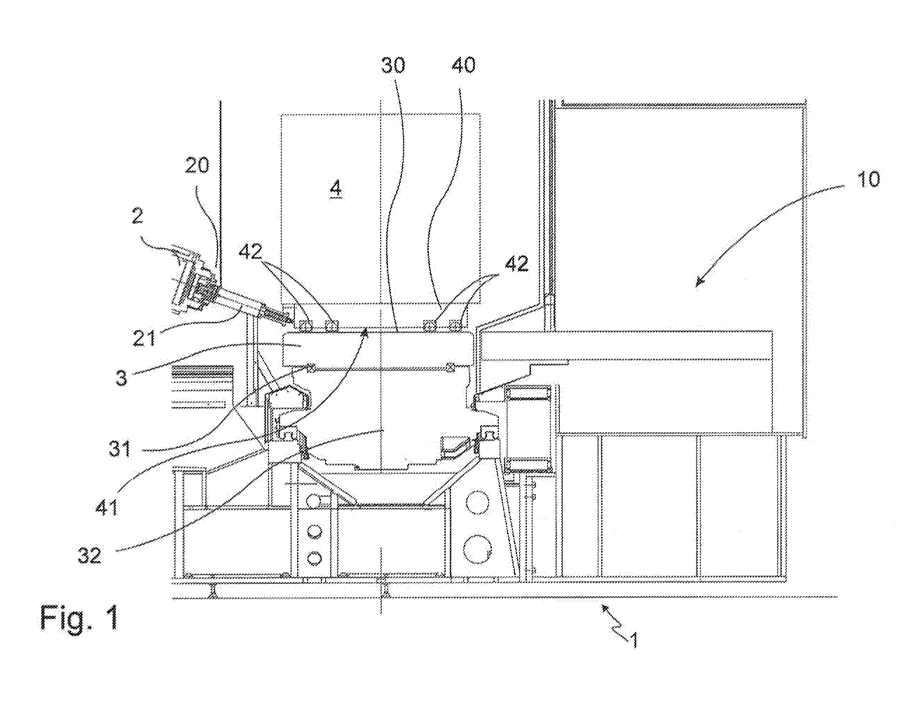

FIG. 1 shows a metal cutting machine tool 1 according to an example of the invention.

The metal cutting machine tool 1 is provided with a preparation area 10. This area is provided for introducing a work piece 4, which has to be machined by the metal cutting machine tool 1, into the metal cutting machine tool 1, or for removing it from the same.

The metal cutting machine tool 1 is also provided with a motor spindle 2. This motor spindle is provided with a tool holder 20 for holding a tool, such as, for example, a drill bit. In the present case, in the condition shown in FIG. 1, the tool holder 20 does not hold any usual tool, but a coupling piece 21. This is used as described in the following.

The metal cutting machine tool 1 is provided with a work piece table 3. On this table, a work piece table surface 30 is formed. The work piece table 3 is basically used for carrying the work piece 4, for example a motor block, for machining. This can be performed directly, i.e. by directly carrying the work piece 4 on the work piece table surface 30, or indirectly, i.e. by interposing a pallet 40. The latter case is shown in FIG. 1.

The work piece table 3 is rotatably supported by a bearing 31. It is therefore rotatable about a work piece table axis 32. By means of a rotary drive, not shown, the work piece table 3 may be rotated actively about the work piece table axis 32. This allows for the positioning of a tool in different positions, in particular regarding the angular position, without requiring a particularly ample mobility of the motor spindle, which is costly in terms of apparatus.

The work piece 4 is supported on the already described pallet. This pallet forms a basis for work piece 4 during the machining operation and also during loading and unloading.

The pallet 40 is provided on its underside 41 with a number, in this case a total of four, rollers 42. By means of these rollers 42, the pallet 40 may be moved horizontally. In this way it is possible to move or displace the pallet 40 between the work piece table 3 and the preparation area 10.

The motor spindle 2 is provided with a motor spindle linear drive, not shown, by which the motor spindle is limitedly movable in all three spatial directions. This motor spindle linear drive usually is used for displacing the motor spindle 2 and the tool held in it during machining of work piece 4 so that the desired machining of work piece 4 is achieved.

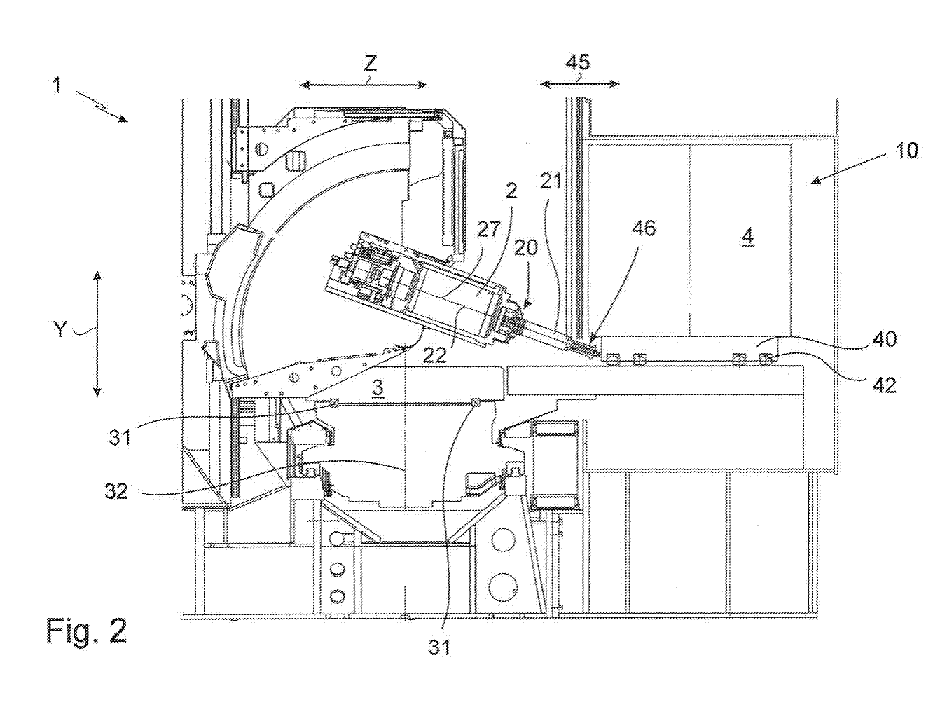

The coupling piece 21 is connected with the pallet 40 in the condition of FIG. 1. The exact mode of execution is explained in the following with reference to FIG. 2.

Due to the use of the coupling piece 21 with the pallet 40, the motor spindle linear drive can not only move the motor spindle 2 with its coupling piece, but also the pallet 40. In particular it can ensure a movement in the horizontal direction, as explained with reference to rollers 42. This corresponds to a movement, which in the metal cutting machine tool 1 shown is required for introducing and removing the tool 4.

The motor spindle linear drive may therefore be used for moving the pallet 40 between the work piece table 3 and the preparation area 10. Neither a manual intervention nor a separate drive are however required.

FIG. 2 shows the metal cutting machine tool 1 of FIG. 1 in another view.

Two of the movement directions of the motor spindle linear drive, i.e. Y and Z, are shown. The Y-direction corresponds to the vertical direction. The Z-direction corresponds to the horizontal direction between work piece table 3 and preparation area 10. It is understood that the motor spindle 2 is also movable about an X-direction, which is horizontal and perpendicular to the shown directions Y and Z as well as to the plane of the drawing in FIG. 2. The motor spindle 2 is also rotatable around a first rotation axis 27.

The motor spindle 2 is provided with a motor spindle 22, around which the motor spindle 2 may rotate a tool or the shown coupling piece 21 too. In case of a tool, it is therefore possible to perform typical machining operations like drilling a bore.

FIG. 2 also shows that pallet 40 is provided with a coupling counterpiece 46. In it the coupling piece 21 is form-fittingly received. Therefore, a formfitting connection is obtained at last between the motor spindle 2 and the pallet 40. If the motor spindle 2 is moved in the Z-direction shown, by its motor spindle linear drive, the pallet 40 is also moved along with it at the same time.

The direction 45 of this movement of pallet 40 is represented by a double arrow. The direction 45 corresponds to the Z-direction of the motor spindle linear drive. It is to be noted that such a movement induced by the motor spindle linear drive of pallet 40 may be achieved independently from the fact that the motor spindle axis 22 is horizontal, or, as shown in FIG. 2, it is inclined.

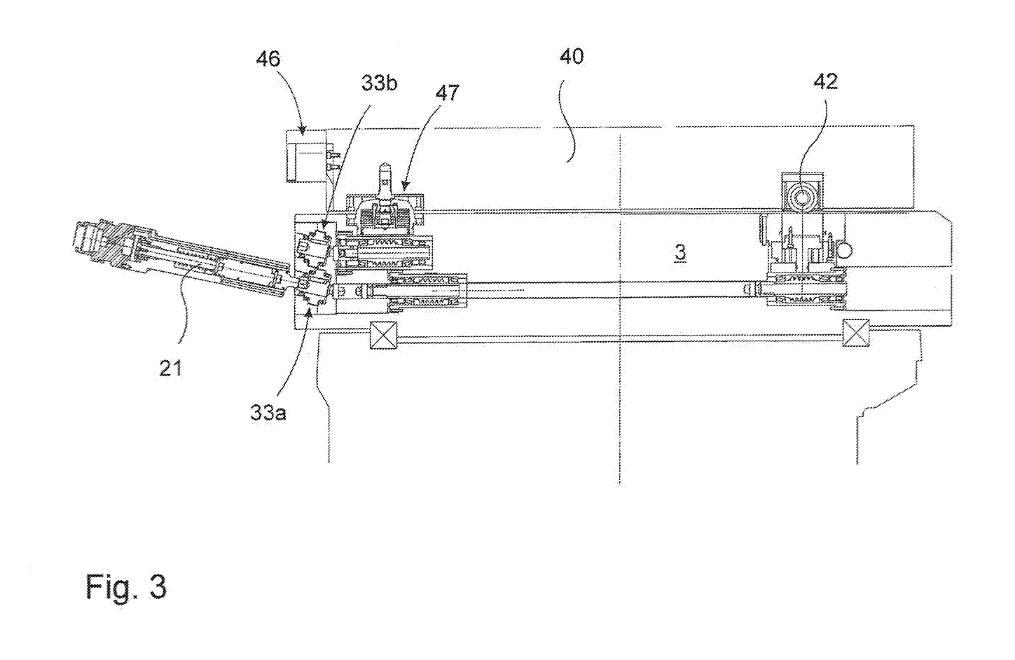

FIG. 3 shows the work piece table 3 as well as the coupling piece 21 in enlarged detail view, wherein the coupling piece 21 is also shown in another position.

As shown, the work piece table 3 is provided with a first power connection 33a and a second power connection 33b. These power connections 33a, 33b are provided for allowing the coupling piece 21 to engage with them, and also to rotate them. In this way, power can be transmitted from the coupling piece 21, in the end therefore from the motor spindle 2, to the work piece table 3.

This power may be used in particular to be transmitted to pallet 40. To this end, the pallet 40 may be provided with power receiving means 47. In particular, a rotation of the motor spindle 2 may be therefore transformed into a movement of the pallet 40. In this way, for example, clamping means on pallet, not shown, may be operated to hold and/or clamp the work piece 4.

The motor spindle 2 may therefore be used not only for displacing the pallet 40, but also for driving clamping means. This can avoid additional manual operations or special driving apparatus.

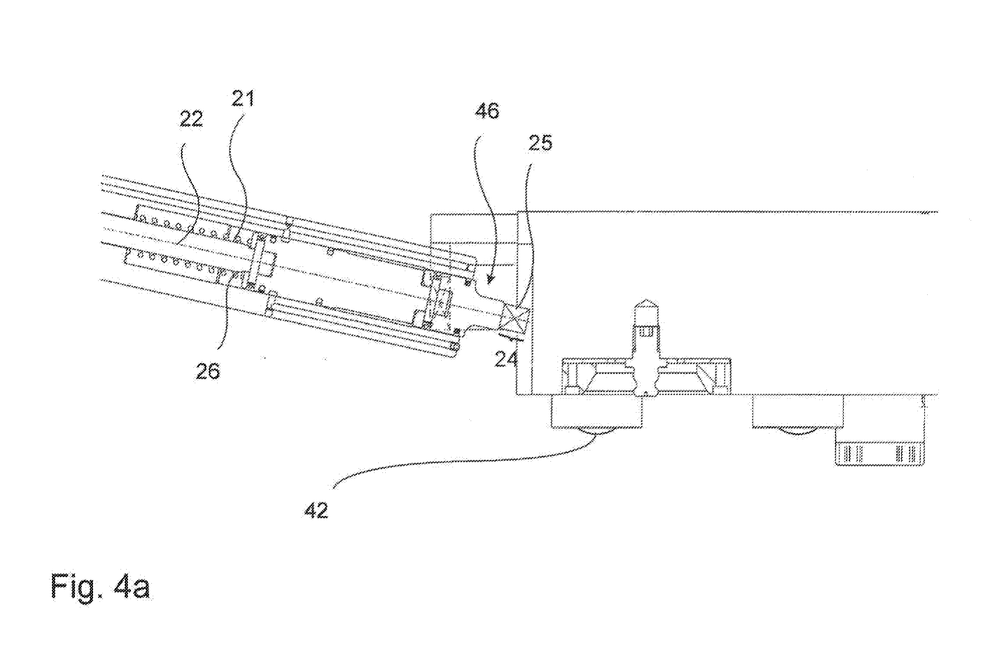

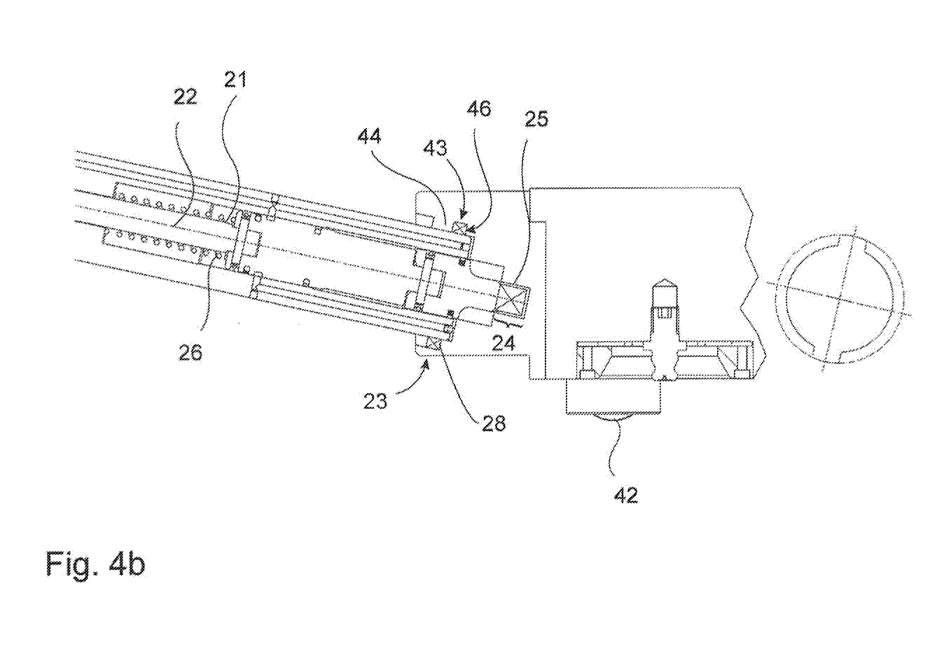

FIG. 4a shows the coupling piece 21 in the coupling counterpiece 46 in greater detail. It can be appreciated that on the right end portion 24 of coupling piece 21 a polygon 25, in this case a square, is formed. In order to push this to the right, in the coupling piece 21 an elastic support 26 is also provided.

The polygon 25 may be used in particular for transmitting a torque to the work piece table 3. For example, this can take place when the coupling piece 21 is received in one of the power connections 33a, 33b.

FIG. 4b shows an embodiment, which, with respect to the embodiment of FIG. 4a, is modified in that the coupling counterpiece 46 is provided with an undercut 43, which is delimited by an edge 44. In the undercut 43 a protrusion 28 of coupling piece 21 may be housed, which is formed in a protruding portion 23 of coupling piece 21. This protrusion 28 ensures, in the condition shown, a form-fitting connection between the coupling piece 21 and the coupling counterpiece 46, which allows an at least almost or completely play-free transmission of force between the coupling piece 21 and the pallet 40.

In the following, possible characteristics of the proposal are provided in a structured manner. The following structurally defined features may be combined to each other in any possible way, and may be included in the claims of the application in any combination. The skilled in the art knows that the invention may be already obtained from the subject matter with a minimum of features. In particular, following advantageous or possible embodiments are presented, which however are not the only possible.

The invention comprises:

A metal cutting machine tool with at least one motor spindle, which rotatably drives a respective tool and a work piece table, at or on which the at least one work piece is directly or indirectly clamped, by means of a pallet carrying the work piece during the machining process, wherein for transport of the work piece or the pallet carrying the work piece from a preparation area to the work piece table and back, on the work piece table surface a sliding or rolling track is provided, on which the work piece or pallet rests for transport, or the pallet is provided on the underside with sliding rails or rollers, and the motor spindle may be movably positioned at least along a first linear axis through a first motor spindle linear drive, and the motor spindle linear drive is also provided for moving the work piece from the preparation area to the work piece table and back.

The metal cutting machine tool as previously defined, wherein the motor spindle is coupled to the pallet or work piece for transmitting a moving force for transporting the work piece from the preparation area to the work piece table or back and the moving force is derived from the motion of the motor spindle provided by the motor spindle linear drive.

The metal cutting machine tool as previously defined, wherein a coupling piece may be inserted into the work piece holder of the motor spindle, and the coupling piece cooperates with a coupling counterpiece provided on the work piece or the pallet for transmitting the moving force to the work piece or pallet.

The metal cutting machine tool as previously defined, wherein the coupling counterpiece is provided with at least one undercut cooperating in a formfitting way with at least one element of the coupling piece, in order to transmit a moving force both in a pulling and pushing direction.

The metal cutting machine tool as previously defined, wherein the coupling piece has at least one portion protruding radially outwards or inwards, with respect to the motor spindle axis, and the motor spindle rotates the coupling piece protruding into or engaging over the coupling counterpiece such as the protruding portion cooperates with the edge delimiting the undercut.

The metal cutting machine tool as previously defined, wherein the coupling piece is provided with a polygon provided for transmission of a torque, which is positioned on a portion, in particular an end portion facing away from the stem.

The metal cutting machine tool as previously defined, wherein the end portion preferably has an elastic support.

The metal cutting machine tool as previously defined, wherein the motor spindle may be movably positioned along a second linear axis, forming an angle, preferably perpendicularly, with respect to the first linear axis, through a second motor spindle drive, and/or the motor spindle may be rotatably positioned about a first rotation axis through a rotating drive, and in particular the rotation axis is perpendicular to the first and/or second linear axis.

The metal cutting machine tool as previously defined, wherein the work piece table may be moved and positioned, forming an angle, preferably perpendicularly, with respect to the rotation axis, by a work piece table drive.

The metal cutting machine tool as previously defined, wherein the moving force results from a superposition of a linear movement of the motor spindle along the first and/or second linear axis and/or the rotational movement of the motor spindle about the rotation axis.

The metal cutting machine tool as previously defined, wherein during the transmission of the moving force, the motor spindle axis forms an acute angle with the first linear axis or the motor spindle axis is parallel to the direction of the moving force.

The invention also refers to a metal cutting machine tool with at least one motor spindle rotatably driving a respective tool and a work piece table, on which the work piece is clamped during the machining, wherein, for transporting the work piece from a preparation area to the work piece table and back, a roller track is provided on the work piece table surface, on which the work piece or the pallet for transporting the same is resting, and the motor spindle is movably positioned at least along a first linear axis through a first motor spindle linear drive, and the motor spindle linear drive is also used for moving the work piece from the preparation area to the work piece table and back.

The invention also refers to a method for swapping in a work piece from a preparation area onto the work piece table inside a cutting machine tool, in particular according to any one of preceding claims, wherein in the tool holder of the motor spindle of the machine tool at least one coupling piece is swapped, and thence the motor spindle with the coupling piece is positioned by the motor spindle linear drive on the work piece or on the pallet carrying the work piece, so that a moving force for feeding the work piece from the preparation area to the work piece table is transmitted, and, after the work piece is positioned on the work piece table, the coupling piece is extracted from the tool holder and a cutting tool is inserted into the tool holder.

In this method, it can be envisaged that, after the motor spindle has positioned the work piece on the work piece table, the motor spindle is separated from the pallet or work piece, and then the motor spindle is positioned onto the work piece table such as the coupling piece held by the motor spindle is introduced into a power connection of the work piece table and then it supplies power to the work piece table for performing the operations of the work piece table, as for example the lowering of the work piece or of the pallet onto the work piece table or the clamping of the work piece on the work piece table.

The invention also comprises a system, comprising at least a metal cutting machine tool according to one or more variants or embodiments of the invention, and a pallet, which directly or indirectly carries the at least one work piece, wherein the motor spindle linear drive is used also for moving the work piece from the preparation area to the work piece table and back.

The claims now provided with the application and those which are provided at a later time, do not cause prejudice to the achievement of a further protection.

If, in this case, in performing a more thorough investigation, in particular also of the corresponding state of the art, it is ascertained that any one of the features may be advantageous for the object of the invention, but not of crucial importance for the achievement of such object, it is obvious that a formulation is already envisaged, which does not include such a feature, in particular in the main claim. Such a sub-combination is covered by the disclosure of the present application.

It is also to be noted that the different forms and variants of the invention, which have been described in the various embodiments and which are shown in the figures, may be arbitrarily combined with each other. Single or multiple features may in particular be arbitrarily swapped. These combinations of features are also disclosed.

The references provided in the dependent claims relate to the further development of the subject of the main claim through the features of the particular dependent claim. However, this should not be construed as a waiver of the right to independent, objective protection of the features of the dependent claims.

Features, which are only disclosed in the description or even single features from claims, which comprise a plurality of features, may be introduced, as of inventive importance, for delimiting the state of the art, in the independent claim/claims, also when such features have been cited together with other features, or when they attain particularly favorable results in connection with other features.

What is claimed is:

1. A metal cutting machine tool with at least one motor spindle, which rotatably drives a respective tool and a work piece table, at or on which the at least one work piece is directly or indirectly clamped, by means of a pallet carrying the work piece during the machining process, wherein for transport of the work piece or the pallet carrying the work piece from a preparation area to the work piece table and back, on the work piece table surface a sliding or rolling track is provided, on which the work piece or pallet rests for transport, or the pallet is provided on the underside with sliding rails or rollers, and the motor spindle is arranged to be movably positioned at least along a first linear axis (Z) through a first motor spindle linear drive, and the motor spindle linear drive is also provided for moving the work piece from the preparation area to the work piece table (3) and back.

2. The machine tool according to claim 1, characterized in that the motor spindle is coupled to the pallet or work piece for transmitting a moving force for transporting the work piece from the preparation area to the work piece table or back and the moving force is derived from the motion of the motor spindle provided by the motor spindle linear drive.

3. The machine tool according to claim 2, characterized in that a coupling piece is arranged to be inserted into the work piece holder of the motor spindle, and the coupling piece cooperates with a coupling counterpiece provided on the work piece or the pallet for transmitting the moving force to the work piece or pallet, wherein, the coupling counterpiece is provided with at least one undercut cooperating in a formfitting way with at least one element of the coupling piece, in order to transmit a moving force both in a pulling and pushing direction.

4. The machine tool according to claim 3, characterized in that the coupling piece has at least one portion protruding radially outwards or inwards, with respect to the motor spindle axis, and the motor spindle rotates the coupling piece protruding into or engaging over the coupling counterpiece such as the protruding portion cooperates with the edge delimiting the undercut, and/or the coupling piece is provided with a polygon provided for transmission of a torque, which is positioned on a portion facing away from the stem, wherein the portion has an elastic support.

5. The machine tool according to claim 4, characterized in that the motor spindle is adapted to be movably positioned along a second linear axis (Y), forming an angle, preferably perpendicularly, with respect to the first linear axis (Z), through a second motor spindle drive, and/or the motor spindle is arranged to be rotatably positioned about a first rotation axis through a rotating drive, and in particular the rotation axis is perpendicular to the first (Z) and/or second linear axis (Y), and/or the work piece table is arranged to be rotatably positioned, forming an angle, with respect to the rotation axis through a work piece table drive.

6. The machine tool according to claim 5, characterized in that the moving force results from a superposition of a linear movement of the motor spindle along the first (Z) and/or second linear axis (Y) and/or the rotational movement of the motor spindle about the rotation axis, and/or during the transmission of the moving force, the motor spindle axis forms an acute angle with the first linear axis (Z) or the motor spindle axis is parallel to the direction of the moving force.

7. A metal cutting machine tool with at least one motor spindle rotatably driving a respective tool and a work piece table, on which the work piece is clamped during the machining, wherein, for transporting the work piece from a preparation area to the work piece table and back, a roller track is provided on the work piece table surface, on which the work piece or the pallet for transporting the work piece is resting, and the motor spindle is movably positioned at least along a first linear axis (Z) through a first motor spindle linear drive, and the motor spindle linear drive is arranged for moving the work piece from the preparation area to the work piece table and back.

8. A method for swapping in a work piece from a preparation area onto the work piece table inside a cutting machine tool according to claim 1, wherein in the tool holder of the motor spindle of the machine tool at least one coupling piece is swapped, and thence the motor spindle with the coupling piece is positioned by the motor spindle linear drive on the work piece or on the pallet carrying the work piece, so that a moving force for feeding the work piece from the preparation area to the work piece table is transmitted, and, after the work piece is positioned on the work piece table, the coupling piece is extracted from the tool holder and a cutting tool is inserted into the tool holder.

9. The method according to claim 8, characterized in that, after the motor spindle has positioned the work piece on the work piece table, the motor spindle is separated from the pallet or work piece, and then the motor spindle is positioned onto the work piece table such as the coupling piece held by the motor spindle is introduced into an energy connection of the work piece table and thence energy for performing the operations of the work piece table, as for example the lowering of the work piece or of the pallet onto the work piece table or the clamping of the work piece on the work piece table, is supplied to the work piece table (3).

10. A system, at least comprising a metal cutting machine tool according to claim 1, and a pallet, which directly or indirectly carries the at least one work piece, wherein the motor spindle linear drive is used also for moving the work piece from the preparation area to the work piece table and back.
